(19) United States
(12) Patent Application Publication
(10) Pub. No.: US 2023/0004447 A1
(43) Pub. Date: Jan. 5, 2023

(54) HARVESTING AND USING EXCESS CAPACITY ON LEGACY WORKLOAD MACHINES

(71) Applicant: CloudNatix, Inc., Saratoga, CA (US)

(72) Inventors: Rohit Seth, Saratoga, CA (US); Kenji Kaneda, Cupertino, CA (US); Somik Behera, San Francisco, CA (US); Guangrui Fu, Palo Alto, CA (US); Ruyang Lin, San Francisco, CA (US)

(21) Appl. No.: 17/857,107

(22) Filed: Jul. 4, 2022

Related U.S. Application Data
(60) Provisional application No. 63/218,384, filed on Jul. 4, 2021.

(51) Int. Cl. G06F 9/50

(52) U.S. Cl. CPC G06F 9/5077; G06F 9/505; G06F 9/5088; G06F 9/5072; G06F 2209/505; G06F 2209/503

(57) ABSTRACT

Some embodiments provide a novel method for deploying containerized applications. The method of some embodiments deploys a data collecting agent on a machine that operates on a host computer and executes a set of one or more workload applications. From this agent, the method receives data regarding consumption of a set of resources allocated to the machine by the set of workload applications. The method assesses excess capacity of the set of resources for use to execute a set of one or more containers, and then deploys the set of one or more containers on the machine to execute one or more containerized applications. In some embodiments, the set of workload applications are legacy workloads deployed on the machine before the installation of the data collecting agent. By deploying one or more containers on the machine, the method of some embodiments maximizes the usages of the machine, which was previously deployed to execute legacy non-containerized workloads.

### BACKGROUND

In recent years, there has been a surge of migrating workloads from private datacenters to public clouds. Accompanying this surge has been an ever increasing number of players providing public clouds for general purpose compute infrastructure as well as specialty services. Accordingly, more than ever, there is a need to efficiently manage workloads across different public clouds of different public cloud providers.

### BRIEF SUMMARY

Some embodiments provide a novel method for harvesting excess compute capacity in a set of one or more datacenters, and using the harvested excess capacity to deploy containerized applications. The method of some embodiments deploys data collecting agents on several machines (e.g., virtual machines, VMs, or Pods) operating on one or more host computers in a datacenter and executing a set of one or more workload applications. In other embodiments, the data collecting agents are deployed on hypervisors executing on host computers. In some embodiments, these workload applications are legacy non-containerized workloads that were deployed on the machines before the installation of the data collecting agents.

From each agent deployed on a machine, the method iteratively (e.g., periodically) receives consumption data that specifies how much of a set of resources that is allocated to the machine is used by the set of workload applications. For each machine, the method iteratively (e.g., periodically) computes excess capacity of the set of resources allocated to the machine. The method uses the computed excess capacities to deploy on at least one machine a set of one or more containers to execute one or more containerized applications. By deploying one or more containers on one or more machines with excess capacity, the method of some embodiments maximizes the usages of the machine(s). The method of some embodiments is implemented by a set of one or more controllers, e.g., a controller cluster for a virtual private cloud (VPC) with which the machine is associated.

In some embodiments, the method stores the received, collected data in a time series database, and assesses the excess capacity by analyzing the data stored in this database to compute a set of excess capacity values for the set of resources (e.g., one excess capacity value for the entire set, or one excess capacity value for each resource in the set). The set of resources in some embodiments include at least one of a processor, a memory, and a disk storage of the host computer on which the set of workload applications execute.

In some embodiments, the received data includes data samples regarding amounts of resources consumed at several instances in time. Some embodiments store raw, received data samples in the time series database, while other embodiments process the raw data samples to derive other data that is then stored in the time series database. The method of some embodiments analyzes the raw data samples, or derived data, stored in the time series database, in order to compute the excess capacity of the set of resources. In some embodiments, the set of resources includes different portions of different resources in a group of resources of the host computer that are allocated to the machine (e.g., portions of a processor core, a memory, and/or a disk of a host computer that are allocated to a VM on which the legacy workloads execute).

To deploy the set of containers, the method of some embodiments deploys a workload first Pod, configures the set of containers to operate within the workload first Pod, and installs one or more applications to operate within each configured container. In some embodiments, the method also defines an occupancy, second Pod on the machine, and associates with this Pod a set of one or more resource consumption data values collected regarding consumption of the set of resources by the set of workload applications, or derived from this collected data. Some embodiments deploy an occupancy, second Pod on the machine, while other embodiments simply define one such Pod in a data store in order to emulate the set of workload applications. Irrespective of how the second Pod is defined or deployed, the method of some embodiments provides data regarding the set of resource consumption values associated with the occupancy, second Pod to a container manager for the container manager to use to manage the deployed set of containers on the machine. These embodiment use the occupancy Pod because the container manager does not manage nor has insight into the management of the set of workload applications.

The method of some embodiments iteratively collects data regarding consumption of the set of resources by the set of containers deployed on the workload first Pod. The container manager iteratively analyzes this data along with consumption data associated with the occupancy, second Pod (i.e., with data regarding the use of the set of resources by the set of workload applications). In each analysis, the container manager determines whether the host computer has sufficient resources for the deployed set of containers. When it determines that the host computer does not have sufficient resources, the container manager designates one or more containers in the set of containers for migration from the host computer. Based on this designation, the containers are then migrated to one or more other host computers.

The method of some embodiments uses priority designations (e.g., designates the occupancy, second Pod as a lower priority Pod than the workload first Pod) to ensure that when the set of resources are constrained on the host computer, the containerized workload Pod will be designated for migration from the host computer, or designated for a reduction of their resource allocations. This migration or reduction of resources, in turn, ensures that the computer resources have sufficient capacity for the set of workload application. In some embodiments, one or more containers in the set of containers can be migrated from the resource constrained machine, or have their allocation of the resources reduced.

After deploying the set of containers, the method of some embodiments provides configuration data to a set of load balancers that configure these load balancers to distribute API calls to one or more containers in the set of containers as well as to other containers executing on the same host computer or on different host computers. When a subset of containers in the deployed set of containers is moved to another computer or machine, the method of some embodiments then provides updated configuration data to the set of load balancers to account for the migration of the subset of containers.

Some embodiments provide a method for optimizing deployment of containerized applications across a set of one or more VPCs. The method is performed by a set of one or more global controllers in some embodiments. The method collects operational data from each cluster controller of a VPC that is responsible for deploying containerized applications in its VPC. The method analyzes the operational data to identify modifications to the deployment of one or more containerized applications in the set of VPCs. The method produces a recommendation report for displaying on a display screen, in order to present the identified modifications as recommendations to an administrator of the set of VPCs

When the containerized applications execute on machines operating on host computers in one or more datacenters, the identified modifications can include moving a group of one or more containerized applications in a first VPC from a larger, first set of machines to a smaller, second set of machines. The second set of machines can be a smaller subset of the first set of machines, or can include at least one other machine not in the first set of machines. In some embodiments, moving the containerized applications to the smaller, second set of machines reduces the cost for deployment of the containerized applications by using less deployed machines to execute the containerized applications.

The optimization method of some embodiments analyzes operational data by (1) identifying possible migrations of each of a group of containerized applications to new candidate machines for executing containerized application, (2) for each possible migration, using a costing engine to compute a cost associated with the migration, (3) using the computed costs to identify the possible migrations that should be recommended, and (4) including in the recommendation report each possible migration that is identified as a migration that should be recommended. In response to user input accepting a recommended migration of a first containerized application from a first machine to a second machine, the method directs a first cluster controller set of the first VPC to direct the migration of the first containerized application.

In some embodiments, the computed costs are used to calculate different output values of a cost function, with each output value associated with a different deployment of the group of containerized applications. Some of these embodiments use the calculated output values of the cost function to identify the possible migrations that should be recommended. The computed costs include financial costs for deploying a set of containerized applications in at least two different public clouds (e.g., two different public clouds operated by two different public cloud providers).

The optimization method of some embodiments also analyzes operational data by identifying possible adjustments to resources allocated to each of a group of containerized applications, and produces a recommendation report by generating a recommended adjustment to at least a first allocation of a first resource to at least a first container/Pod on which a first container application executes.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings, and the Claims is needed. Moreover, the claimed subject matters are not to be limited by the illustrative details in the Summary, Detailed Description, and the Drawings.

### BRIEF DESCRIPTION OF FIGURES

The novel features of the invention are set forth in the appended claims. However, for purposes of explanation, several embodiments of the invention are set forth in the following figures.

FIGS. 1 and 2 conceptually illustrate two processes that implement the method of some embodiments of the invention.

FIG. 3 illustrates a VPC controller cluster of some embodiments.

FIG. 4 illustrates examples of occupancy Pods that are defined on machines with legacy workloads.

FIG. 5 illustrates a process that is performed in some embodiments to continuously monitor consumption of resources on machines with containerized workloads, and to migrate, or to adjust resource allocations, to the containerized workloads when the process detects a lack of resources for the legacy workloads on these machines.

FIG. 6 illustrates an example of migrating containerized application(s) to free up additional resources for the legacy workload application(s) on the same machine.

FIG. 7 illustrates an example of reducing the allocation of resources to containerized application(s) to free up additional resources for the legacy workload application(s) on the same machine.

FIG. 8 illustrates a process that some embodiments use to pack containerized and legacy workloads on fewer machines in order to reduce expenses associated with the deployment of the machines in one or more public or private cloud.

FIG. 9 illustrates an example of one packing solution performed by the process of FIG. 8.

FIG. 10 illustrates an example of a global controller with a recommendation engine that generates cost simulation results and optimization plans.

FIG. 11 illustrates a process that a recommendation engine of a global controller performs in some embodiments to provide recommendations regarding optimized deployments of workloads and to implement a recommendation that is selected by an administrator.

FIG. 12 illustrates an example of re-deployment of workloads pursuant to a recommendation generated by the recommendation engine.

FIG. 13 illustrates a user interface through which a global controller provides the right-sizing recommendation in some embodiments.

FIG. 14 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a novel method for deploying containerized applications. The method of some embodiments deploys a data collecting agent on a machine that operates on a host computer and executes a set of one or more workload applications. From this agent, the method receives data regarding consumption of a set of resources allocated to the machine by the set of workload applications. The method assesses excess capacity of the set of resources that is available for use to execute a set of one or more containers, and then deploys the set of one or more containers on the machine to execute one or more containerized applications. In some embodiments, the set of workload applications are legacy workloads deployed on the machine before the installation of the data collecting agent. By deploying one or more containers on the machine, the method of some embodiments maximizes the usages of the machine, which was previously deployed to execute legacy non-containerized workloads.

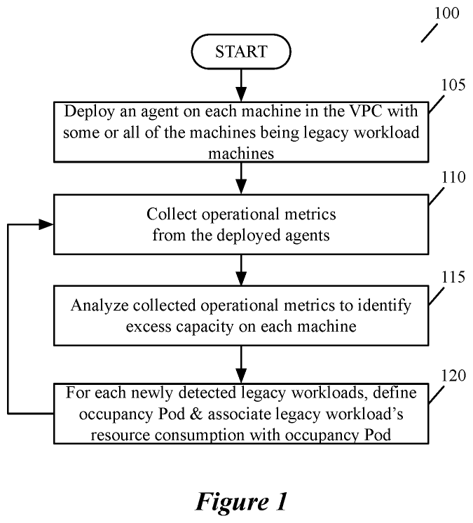

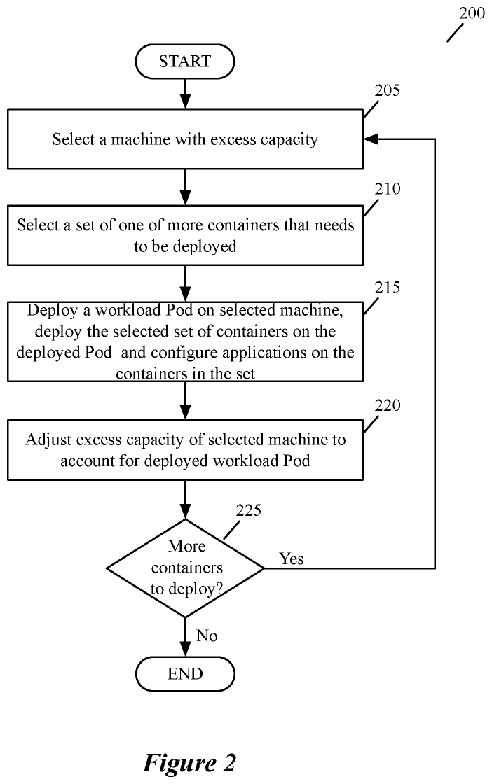

FIGS. 1 and 2 conceptually illustrate two processes 100 and 200 that implement the method of some embodiments of the invention. These processes will be explained by FIG. 3, which illustrates a VPC controller cluster 300 of some embodiments. This controller cluster executes the process 100 of FIG. 1 to harvest excess compute capacity on machines deployed in the VPC 305, and executes the process 200 of FIG. 2 to use the harvested excess capacity to deploy containerized applications on these machines. The illustrations of the processes 100 and 200 is conceptual for some embodiments, as in these embodiments, the operations of these processes are performed by multiple sub-processes.

Multiple VPCs 305 are illustrated in FIG. 3. Each of these VPCs is deployed in a public or private cloud in some embodiments. Each cloud includes one or more datacenters, with the public clouds having datacenters that are used by multiple tenants and the private clouds having datacenters that are used by one entity. As shown, each VPC has its own VPC controller cluster 300 (implemented by one or more controller servers) that communicates with a cluster of global controllers 310.

In some embodiments, a network administrator computer 315 interacts through a network 320 (e.g., a local area network, a wide area network, and/or the internet) with the global controller clusters 310 to specify workloads, policies for managing the workloads, and the VPC(s) managed by the administrator. The global controller cluster 310 then directs through the network 320 the VPC controller cluster 300 to deploy these workloads and effectuate the specified policies.

Each VPC includes several host computers 325, each of which executes one or more machines 330 (e.g., virtual machines, VMs, or Pods). Some or all of these machines 330 execute legacy workloads 335 (e.g., legacy applications), and are managed by legacy compute managers (not shown). The VPC controller cluster 300 communicates with the host computers 325 and their machines 330 through a network 340 (e.g., through the LAN of the datacenter(s) in which the VPC is defined).

Each VPC controller cluster 300 performs the process 100 to harvest excess capacity of machines 330 in its VPC 305. In some embodiments, the process 100 initially deploys (at 105) a data collecting agent 345 on each of several machines 330 in the VPC 305. In some embodiments, the VPC controller cluster 300 has a cluster agent 355 that directs the deployment of the data collecting agents 345 on the machines 330. Some or all of these machines 330 execute legacy workloads 335 (e.g., legacy applications, such as webserver, application servers, database servers). These machines are referred to below as legacy workload machines.

From each deployed agent 345, the process 100 receives (at 110) consumption data (e.g., operational metric data) that can be used to identify the portion of a set of the host-computer resources that is consumed by the set of legacy workload applications that execute on the agent's machine. In some embodiments, the set of host-computer resources is the set of resources of the host computer 325 that has been allocated to the machine 330. When multiple machines 330 execute on a host computer 325, the host computer's resources are partitioned into multiple resources sets with each resource set being allocated to a different machine. Examples of such resources include processor resources (e.g., processor cores or portions of processor cores), memory resources (e.g., portion of the host computer RAM), disk resources (e.g., portion of non-volatile semiconductor or hard disk storage), etc.

Each deployed agent 345 in some embodiments collects operational metrics from an operating system of the agent's machine 330. For instance, in some embodiments, the operating system of each machine has a set of APIs that the deployed agent 345 on that machine 330 can use to collect the desired operational metrics, e.g., the amount of CPU cycles consumed by the workload applications executing on the machine, the amount of memory and/or disk used by the workload applications, etc. In some embodiments, each deployed agent 345 iteratively pushes (e.g., periodically sends) its collected operational metric data since its previous push operation, while in other embodiments the VPC controller cluster 300 iteratively pulls (e.g., periodically retrieves) the operational metrics collected by each deployment agent since its previous pull operation.

In some embodiments, the cluster agent 355 of the VPC controller cluster 300 receives the collected operational metrics (through a push or pull model) from the agents 345 on the machines 330 and stores these metrics in a set of one or more data stores 360. The set of data stores includes a time series data store (e.g., such as Prometheus database) in some embodiments. The cluster agent 355 stores the received data in the time series data store as raw data samples regarding different amounts of resources (e.g., different amounts of processor resource, memory resource, and/or disk resource that are allocated to each machine) consumed at different instances in time by the workload applications executing on the machine.

Conjunctively, or alternatively, a data analyzer 365 of the VPC controller cluster 300 in some embodiments analyzes (at 115) the collected data to derive other data that is stored in the time series database. In some embodiments, the processed data expresses computed excess capacity on each machine 330, while in other embodiments, the processed data is used to compute this excess capacity. The excess capacity computation of some embodiments uses machine learning models that extrapolate future predicted capacity values by analyzing a series of actual capacity values collected from the machines.

The excess capacity of each machine in some embodiments is expressed as a set of one or more capacity values that express an overall excess capacity of the machine 330 for the set of resources allocated to the machine, or an excess capacity per each of several resources allocated to the machine (e.g., one excess capacity value for each resource in the set resources allocated to the machine). Some embodiments store the excess capacity values computed at 115 in the time series data store 360 as additional data samples to analyze.

In some embodiments, the excess capacity computation (at 115) is performed by the Kubernetes (K8) master 370 of the VPC controller cluster 300. In other embodiments, the K8 master 370 just uses the computed excess capacities to migrate containerized workloads deployed by the process 200 or to reduce the amount of resources allocated to the containerized workloads. In these embodiments, the K8 master 370 directs the migration of the containerized workloads, or the reduction of resource to these workloads, after it retrieves the computed excess capacities and detects that one or more machines no longer have sufficient capacity for both the legacy workloads and containerized workloads deployed on the machine(s). The migration containerized workloads and the reduction of resource to these workloads will be further described below by reference to FIG. 2.

At 120, the process 100 (e.g., the cluster agent 355) defines an occupancy Pod on each machine executing legacy workload (e.g., executing legacy workload applications), and associates with this occupancy Pod the set of one or more resource consumption values (i.e., the metrics received at 110, or values derived from these metrics) regarding consumption of the set of resources by the set of workload applications.

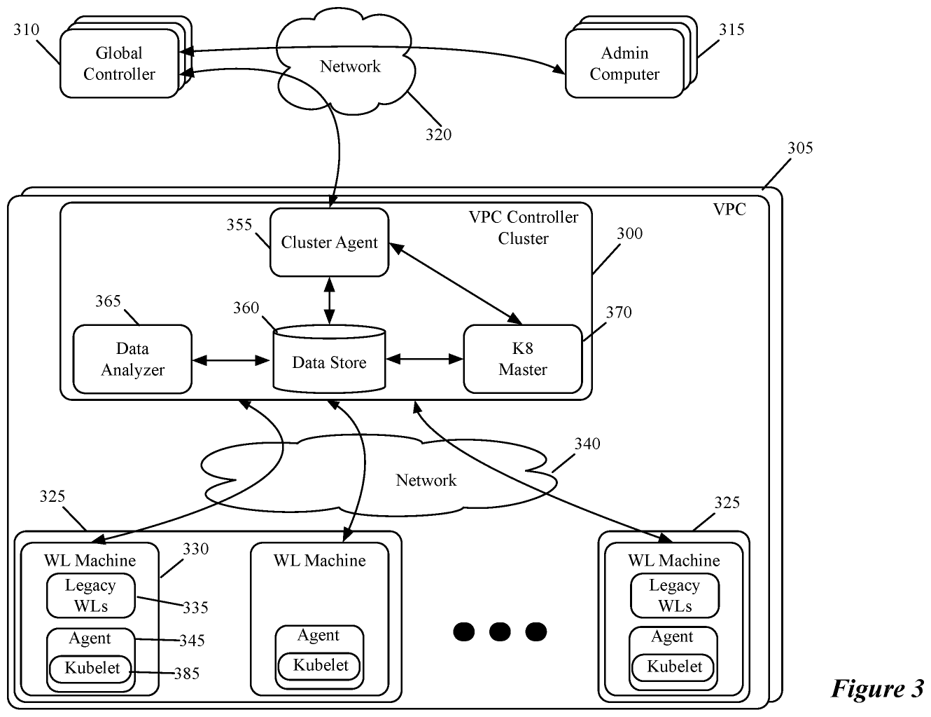

FIG. 4 illustrates examples of occupancy Pods 405 that are defined on machines 330a-d with legacy workloads 335. This figure illustrates two deployment stages 402 and 404 of four machines 330a-d. Three of these machines 330a, 330c, and 330d have occupancy Pods 405. Dashed lines are used to draw the occupancy Pods in this figure in order to illustrate that while these Pods are actually deployed on each machine 330 in some embodiments, in other embodiments they are just Pods that are defined in the data store set 360 to emulate the legacy workloads for the K8 master 370, or for a kubelet 385 that is configured on each agent 345 to operate with the K8 master 370. As described below, the kubelet enforces QoS in some embodiments by reducing allocation of resources or removing lower priority Pods when there is a resource contention (e.g., between legacy workloads and containerized workloads).

Specifically, in some embodiments, the VPC controller cluster 300 deploys the occupancy Pod because neither the K8 manager 370 nor the kubelets 385 manage or have insight into the management of the set of legacy workload applications 335. Hence, the VPC controller cluster 300 uses the occupancy Pod 405 as a mechanism to relay information to the K8 manager 370 and the kubelets 385 regarding the usages of resources by the legacy workload applications 335 on each machine 330. As mentioned above, these resource consumption values are stored in the data store(s) 360 in some embodiments, and are accessible to the K8 master 370. The K8 master 370 uses this data to manage the deployed set of containers as mentioned above and further described below.

In some embodiments, the VPC controller cluster 300 uses priority designations (e.g., designates an occupancy Pod 405 on a machine 330 as having a higher priority than containerized workload Pods) to ensure that when the set of resources are constrained on the host computer, the containerized workload Pod will be designated for migration from the host computer, or designated for a reduction of their resource allocations. This migration or reduction of resources, in turn, ensures that the computer resources have sufficient capacity for the set of workload application. In some embodiments, one or more containers in the set of containers can be migrated from the resource constrained machine, or have their allocation of the resources reduced.

To compute the excess capacity, the cluster agent 355 of the VPC controller cluster 300 in some embodiments estimates the peak CPU/memory usage of legacy workloads 335 by analyzing the data sample records stored in the time series database 360, and sets the request of the occupancy Pod 405 to the peak usage of legacy workloads 335. The occupancy Pod 405 prevents containerized workloads from being scheduled on machines that do not have sufficient resources due to legacy workloads 335. In some embodiments, the peak usage of legacy workloads 335 is calculated by subtracting the Pod total usage from the machine total usage.

The cluster agent 355 sets the QoS class of occupancy Pods 405 to guaranteed by setting the resource limits, and by setting the priority of occupancy Pods 405 to a value higher than the default priority. Based on these two settings, bias the eviction process of the kubelet 385 operating within each host agent 345 to prefer evicting containerized workloads over occupancy Pods. Since both occupancy Pods and containerized workloads are in the guaranteed QoS class, the kubelet 385 evicts containerized workloads, which have lower priority than occupancy Pods. The priority of the occupancy Pods is also needed to allow occupancy Pods to preempt containerized workloads that are already running on a machine. Once occupancy Pods become guaranteed, the OOM (ONAP (Open Network Automation Platform) Operation Manager) operating on the machine 330 will prefer evicting containerized workloads over evicting occupancy Pods since the usage of occupancy Pods in some embodiments is close to 0 (just “sleep” process).

As shown in FIG. 1, the process 100 of some embodiments loops through 110-120 (1) to iteratively collect consumption data regarding the amount of the set of resources consumed on each machine by the legacy workloads 335 and by any containerized applications that are newly deployed by the process 200, and (2) to analyze the collected data to maintain up to date excess capacity data and to ensure that any deployed containerized application does not impair the performance of any legacy workloads 335 deployed on the machines 330. In each iteration, the process 100 identifies any newly deployed legacy workloads 335, for which it then defines an occupancy Pod as described above.

FIG. 2 illustrates the process 200 that uses the computed excess capacities of the legacy workload machines in order to select one or more of these machines and to deploy one or more sets of containers on these machines to execute containerized applications. As mentioned above, the process 200 is executed by the VPC controller cluster 300 in some embodiments. In other embodiments, this process is performed by the global controller cluster 310.

The process 200 starts each time that one or more sets of containerized applications have to be deployed in a VPC 305. The process 200 initially selects (at 205) a machine in the VPC with excess capacity. This machines can be a legacy workload machine with excess capacity, or a machine that executes no legacy workloads. In some embodiments, the process 200 selects legacy workload machines so long as such machines are available with a minimum excess capacity of X % (e.g., 30%). When there are multiple such machines, the process 200 selects the legacy workload machine in the VPC with the highest excess capacity in some embodiments.

When the VPC 305 does not have legacy workload machines with the minimum excess capacity, the process 200 selects (at 205) a machine that does not execute any legacy workloads. In some embodiments, the machines that are considered (at 205) by the process 200 for the new deployment are virtual machines executing on host computers. However, in other embodiments, these machines can include BareMetal host computers and/or Pods. At 210, the process 200 selects a set of one or more containers that need to be deployed in the VPC. Next, at 215, the process 200 deploys a workload Pod on the machine selected at 205, deploys the container set selected at 210 onto this workload Pod, and installs and configures one or more applications to run on each container in the container set deployed at 215.

FIG. 4 illustrates the deployment of such workload Pods and containerized applications on these Pods. As mentioned above, the first stage 402 illustrates four machines 330a-d, three of which 330a, 330c, and 330d execute legacy workloads 335, and have an associated occupancy Pod 405, which as mentioned above models the resource consumption of the legacy workloads for the K8 manager 370 and/or its associated kubelets 385. The second stage 404 of FIG. 4 shows two workload Pods 420 deployed on two machines 330a and 330c. On each workload Pod, a container 430 executes, and an application 440 executes on each container.

At 220, the process 200 adjusts the excess capacity of the selected machine to account for the new workload Pod 420 that was deployed on it at 215. In some embodiments, this adjustment is just a static adjustment of the machine's capacity (as stored on the VPC controller cluster data store 360) for a first time period, until data samples are collected by the agent 345 (executing on the selected machine 330) a transient amount of time after the workload Pod starts to operate on the selected machine. In other embodiments, the process 200 does not adjust the excess capacity value of the selected machine 330, but rather allows for this value to be adjusted by the VPC controller cluster processes after the consumption data values are received from the agent 345 deployed on the machine.

After 220, the process 200 determines (at 225) whether it has deployed all the containers that need to be deployed. If so, it ends. Otherwise, it returns to 205 to select a machine for the next container set that needs to be deployed, and then repeats its operations 210-225 for the next container set. By deploying one or more containers on legacy workload machines, the process 200 of some embodiments maximizes the usages of these machines, which were previously deployed to execute legacy non-containerized workloads.

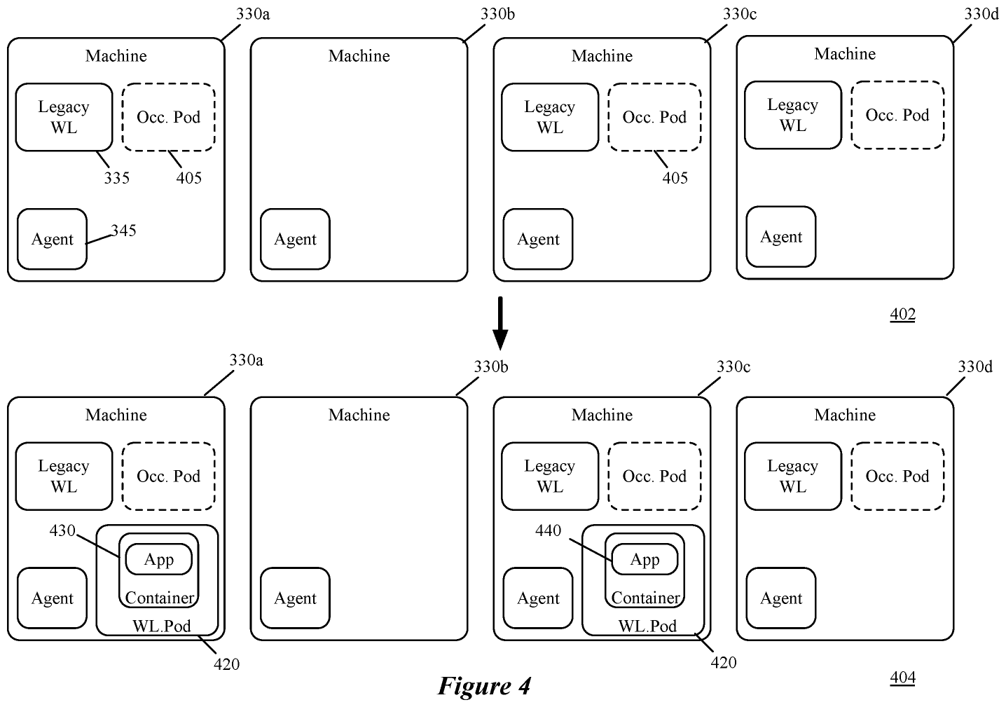

FIG. 5 illustrates a process 500 that is performed in some embodiments to continuously monitor consumption of resources on machines with containerized workloads, and to migrate, or to adjust resource allocations, to the containerized workloads when the process detects a lack of resources for the legacy workloads on these machines. The process 500 is performed iteratively in some embodiments by the K8 master 370 and/or the kubelet 385 of the machine.

As shown, the process 500 collects (at 505) data regarding consumption of resources by legacy and containerized workloads executing on machines in the VPC. At 510, the process analyzes the collected data to determine whether it has identified a lack of sufficient resources (e.g., memory, CPU, disk, etc.) for any of the legacy workloads. If not, the process returns to 505 to collect additional data regarding resource consumption.

Otherwise, when the process identifies (at 510) that the set of resources allocated to a machine are not sufficient for a legacy workload application executing on the machine, the process modifies (at 515) the deployment of the containerized application(s) on the machine to make additional resources available to the legacy workload application. Examples of such a modification include (1) migrating one or more containerized workloads that are deployed on the machine to another machine in order to free up additional resources for the legacy workload application(s) on the machine, or (2) reducing the allocation of resources to one or more containerized workloads on the machine to free up more of the resources for the legacy workload application(s) on the machine.

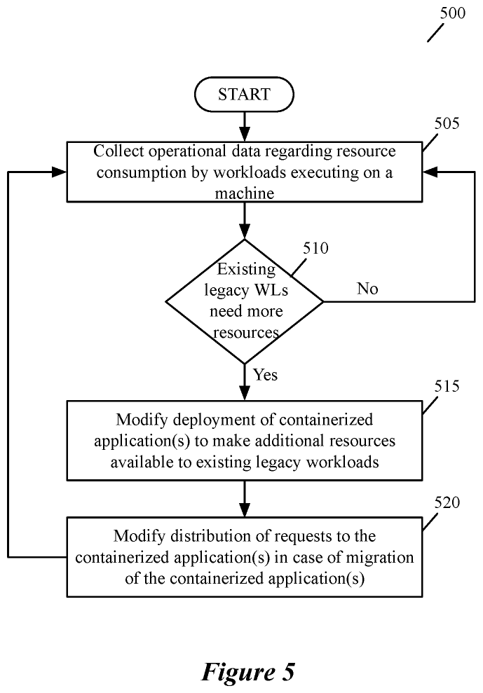

FIG. 6 illustrates an example of migrating containerized application(s) to free up additional resources for the legacy workload application(s) on the same machine. In this example, the legacy workload 335 on machine 330a is consuming more resources (e.g., more CPU, memory and/or disk resources) and this additional consumption does not leave sufficient amount of resources available on the machine 330a for the containerized workload Pod 420. This additional resource consumption is depicted by the larger size of the legacy workloads 335 and its associated occupancy Pod 405 as compared to the representations of these two items in FIG. 4. Because of this additional consumption, the workload Pod 420 has migrated from the machine 330a to the machine 330d, so that the legacy workload 335 can consume additional resources on the machine 330a.

When migrating a containerized application to a new machine, the process 500 moves the containerized application to a machine (with or without legacy workloads) that has sufficient resource capacity for the migrating containerized application. To identify such machines, the process 500 uses the excess capacity computation of the process 100 of FIG. 1 in some embodiments.

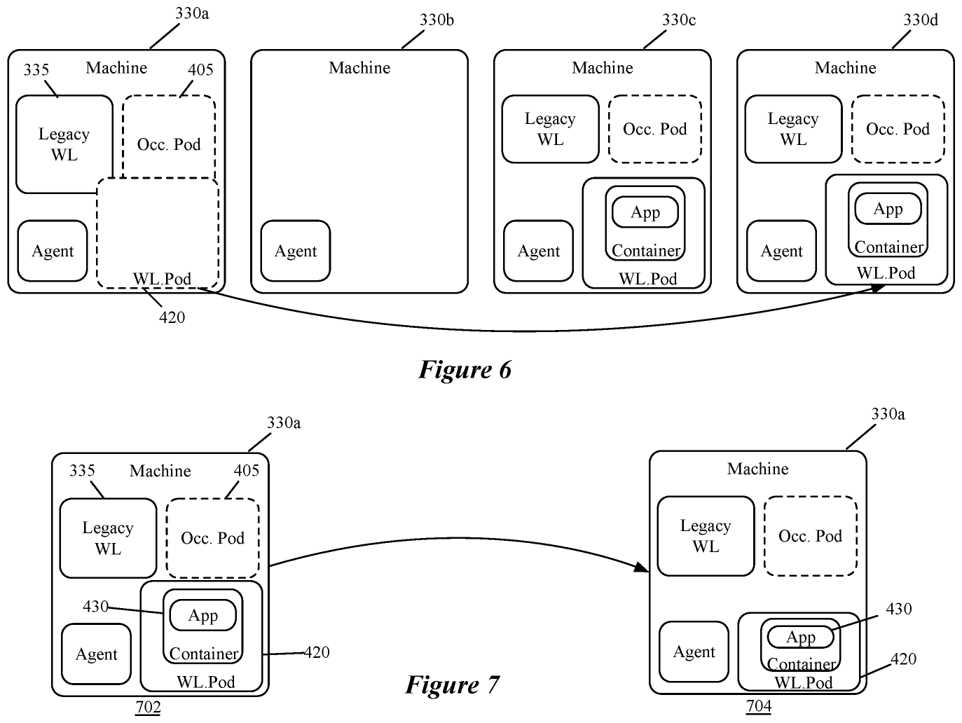

FIG. 7 illustrates an example of reducing the allocation of resources to containerized application(s) to free up additional resources for the legacy workload application(s) on the same machine. This figure shows two operational stages 702 and 704 of the machine 330a. The first operational stage 702 shows that as in FIG. 6, the legacy workload 335 on machine 330a in FIG. 7 is consuming more resources (e.g., more CPU, memory and/or disk resources) in the set of resources allocated to the machine 330a, and this additional resource consumption is depicted by the larger size of the legacy workloads 335 and its associated occupancy Pod 405. The second operational stage 704 then shows the workload Pod 420 remaining on the machine 330a but having less resources allocated to it. This reduced allocation level is as depicted by the smaller size of the workload Pod 420 in the second stage 704.

When the process 500 moves the containerized workload to another machine, the process 500 configures (at 520) forwarding elements and/or load balancers in the VPC to forward API (application programming interface) requests that are sent to the containerized application to the new machine that now executes the containerized application. In some embodiments, the migrated containerized application is part of a set of two or more containerized applications that perform the same service. In some such embodiments, load balancers (e.g., L7 load balancers) distribute the API requests that are made for the service among the containerized applications. After deploying the set of containers, some embodiments provide configuration data to configure a set of load balancers to distribute API calls among the containerized applications that perform the service. When a container is migrated to another computer or machine to free up resources for legacy workloads, the process 500 in some embodiments provides updated configuration data to the set of load balancers to account for the migration of the container. After 520, the process 500 returns to 505 to continue its monitoring of the resource consumption of the legacy and containerized workloads.

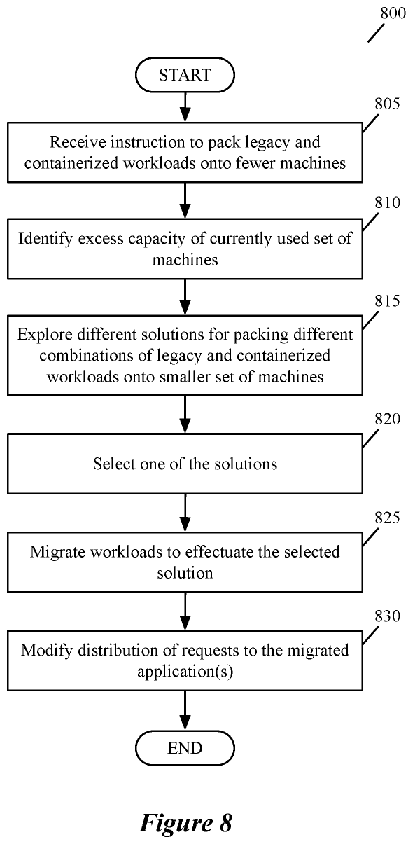

Some embodiments use the excess capacity computations in other ways. FIG. 8 illustrates a process 800 that some embodiments use to pack containerized and legacy workloads on fewer machines in order to reduce expenses associated with the deployment of the machines in one or more public or private cloud. The process 800 is performed by the global controller cluster 310 and the VPC controller cluster(s) 300 of one or more VPCs 305.

As shown, the process 800 starts (at 805) when an administrator directs the global controller cluster 310 through its user interface (e.g., its web interface or APIs) to reduce the number of machines on which the legacy and containerized workloads managed by the administrator are deployed. In some embodiments, these machines can operate in one or more VPCs defined in one or more public or private clouds. When the machines operate in more than one VPC, the administrator's request to reduce the number of machines uses can identify the VPC(s) in which the machines should be examined for the workload migration and/or packing. Alternatively, the administrator's request does not identify any specific VPC to explore in some embodiments.

Next, at 810, the process 800 identifies a set of machines to examine, and for each machine in the set, identifies excess capacity of the set of resources allocated to the machine. The set of machines includes the machines currently deployed in each of the explored VPC (i.e., in each VPC that has a machine that should be examined for workload migration and/or packing). In some embodiments, a capacity-harvesting agent 345 executes on each examined machine and iteratively collects resource consumption data, as described above. In these embodiments, the process 800 uses the collected resource consumption data (e.g., the data stored in a time series data store 360) to compute available excess capacity of each examined machine.

At 815, the process 800 explores different solutions for packing different combinations of legacy and containerized workloads onto a smaller set of machines than the set of machines identified at 810. The process 800 then selects (at 820) one of the explored solutions. In some embodiments, the process 800 uses a constrained optimization search process to explore the different packing solutions and to select an optimal solution from the explored solutions.

The constrained optimization search process of some embodiments uses a cost function that accounts for one or more types of costs. Examples of such costs in some embodiments include resource consumption efficiency cost (meant to reduce the wasting of excess capacity), financial cost (accounting for cost of deploying machines in public clouds), affinity cost (meant to bias towards closer placement of applications that communicate with each other), etc. In other embodiments, the process 800 does not use constrained optimization search processes, but rather uses simpler processes (e.g., greedy processes) to select a packing solution for packing the legacy and containerized workloads onto a smaller set of machines.

After selecting a packing solution, the process 800 migrates (at 825) one or more legacy workloads and/or containerized workloads in order to implement the selected packing solution. The process 800 configures (at 830) forwarding elements and/or load balancers in one or more affected VPCs to forward API (application programming interface) requests that are sent to the migrated workload applications to the new machine on which the workload applications now execute.

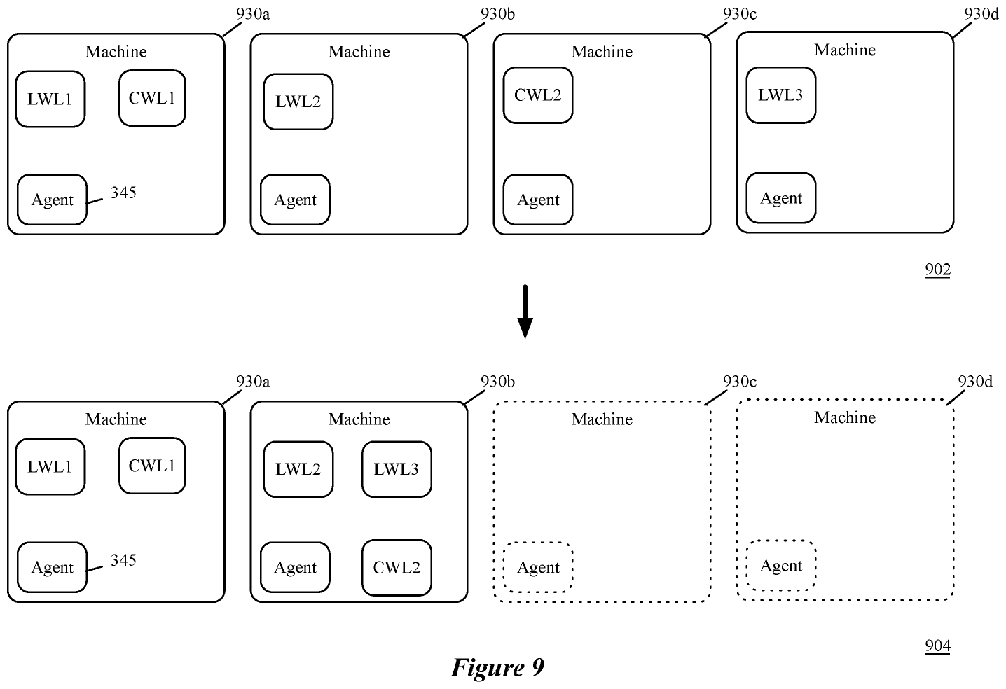

FIG. 9 illustrates an example of one packing solution performed by the process 800. This solution is presented in two operational stages 902 and 904 of four machines 930a-d. Each of these machines executes one or more workloads and a capacity harvesting agent 345. The first stage 902 shows the first machine 930a executing legacy and containerized workloads LWL1 and CWL1, the second machine 930b executing a legacy workload LWL2, the third machine 930c executing containerized workload CWL2, and the fourth machine 930d executing a legacy workload LWL3. The second stage 904 shows that all the legacy and containerized workloads have been packed onto the first and second machines 930a and 930b. This stage depicts the third and fourth machines 930c-d in dashed lines to indicate that these machines have been taken offline as they are no longer used for deployment of any legacy or containerized workload applications.

The packing solution depicted in stage 904 required the migration of the containerized workload CWL2 and the legacy workload LWL3 to the second machine 930b respectively from the third and fourth machines 930c and 930d. Before selecting this packing solution, the process 800 in some embodiments would explore other packing solutions, such as moving the containerized workload CWL2 to the first machine 930a, moving the legacy workload LWL3 to the first machine 930a, moving the containerized workload CWL2 to the fourth machine 930d, moving the legacy workload LWL3 to the third machine 930c, moving the first legacy workload LWL1 and containerized workload CLW1 to one or more other machines, etc. In the end, the process 800 in these embodiments selects the packing solution shown in stage 904 because this solution resulted in an optimal solution with a best computed cost (as computed by the cost function used by the constrained optimization search process).

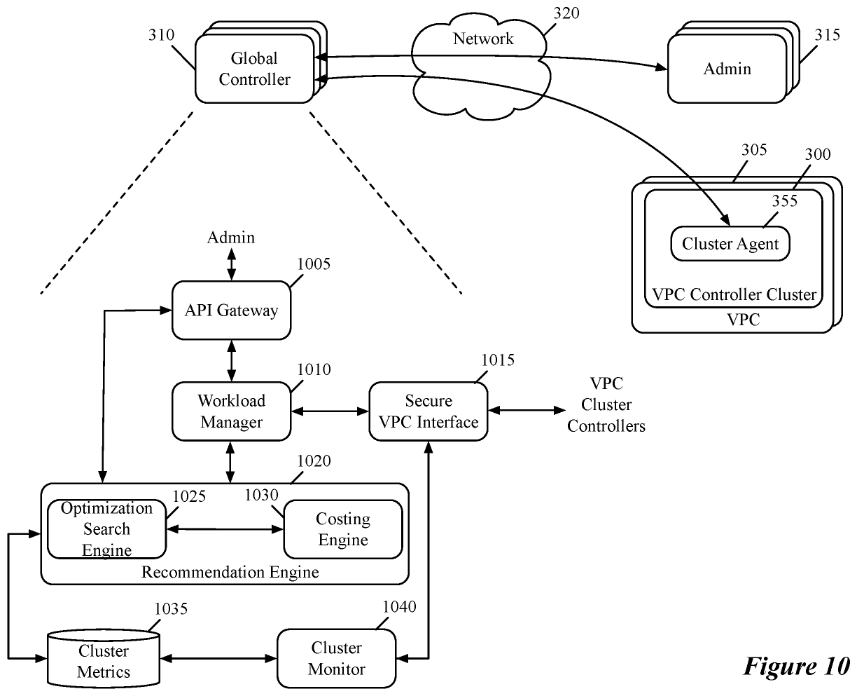

Instead of having a user request the efficient packing of workloads onto fewer machines, or in conjunction with this feature, some embodiments use automated processes to provide recommendations for the dynamic optimization of deployments in order to efficiently pack and/or migrate workloads, and thereby reducing the cost of deployments. FIGS. 10-13 illustrate examples of the dynamic optimization approach of some embodiments.

In these embodiments, the global controller 310 has a recommendation engine that performs the cost optimization. It retrieves historical data from time series database, and generates cost simulation results as well as optimization plans. The recommendation engine generates a report that includes these plans and results. The administrator reviews this report and decides whether to apply one or more of the presented plans. When the administrator decides to apply the plan for one or more of the VPCs, the global controller sends a command to the cluster agent of each affected VPC. Each cluster agent that receives a command then makes the API calls to cloud infrastructure managers (e.g., the AWS managers) to execute the plan (e.g., resize instance types).

FIG. 10 illustrates an example of a global controller 310 with a recommendation engine 1020 that generates cost simulation results and optimization plans. In addition to the recommendation engine 1020, the global controller 310 includes an API gateway 1005, a workload manager 1010, a secure VPC interface 1015, a cluster monitor 1040 and a cluster metric data store 1035. The recommendation engine 1020 includes an optimization search engine 1025 and a costing engine 1030.

The API gateway 1005 enables secure communication between the global controller 310 and the network administrator computer 315 through the intervening network 320. Similarly, the secure VPC interface 1015 allows the global controller 310 to have secure (e.g., VPN protected) communication with one or more VPC controller cluster(s) of one or more VPCs. The workload manager 1010 of the global controller 310 uses the API gateway 1005 and the secure VPC interface 1015 to have secure communications with the network administrators and VPC clusters. Through the gateway 1005, the workload manager can receive instructions from the network administrators, which it can then relay to the VPC controller clusters through the VPC interface 1015.

The cluster monitor 1040 receives operational metrics from each VPC controller cluster through the VPC interface 1015. These operational metrics are metrics collected by the capacity harvesting agents 345 deployed on the machines in each VPC. The cluster monitor 1040 stores the received operational metrics in the cluster metrics data store 1035. This data store is a time series database in some embodiments. In some embodiments, the received metrics are stored as raw data samples collected at different instances in time, while in other embodiments they are processed and stored as processed data samples for different instances in time.

The recommendation engine 1020 retrieves data samples from the time series database, and generates cost simulation results as well as optimization plans. The recommendation engine uses its optimization search engine 1025 to identify different optimization solutions, and uses its costing engine 1030 to compute a cost for each identified solution. For instance, as described above for FIGS. 8 and 9, the constrained optimization search in some embodiments explores different packing solutions and identifies one or more optimal solutions from the explored solutions. Moreover, the costing engine 1030 uses in some embodiments uses a cost function that accounts for one or more types of costs. Examples of such costs in some embodiments include resource consumption efficiency cost (meant to reduce the wasting of excess capacity), financial cost (accounting for cost of deploying machines in public clouds), affinity cost (meant to bias towards closer placement of applications that communicate with each other), etc.

The recommendation engine 1020 generates a report that identifies the usage results that it has identified, as well as the cost simulation and optimization plan that engine has generated. The recommendation engine 1020 then provides this report to the network administrator through one or more electronic mechanisms, such as email, web interface, API, etc. The administrator reviews this report and decides whether to apply one or more of the presented plans. When the administrator decides to apply the plan for one or more of the VPCs, the workload manager 1010 of the global controller 310 sends a command to the cluster agent of the controller cluster of each affected VPC. Each cluster agent that receives a command then makes the API calls to cloud infrastructure managers (e.g., the AWS managers) to execute the plan (e.g., resize instance types).

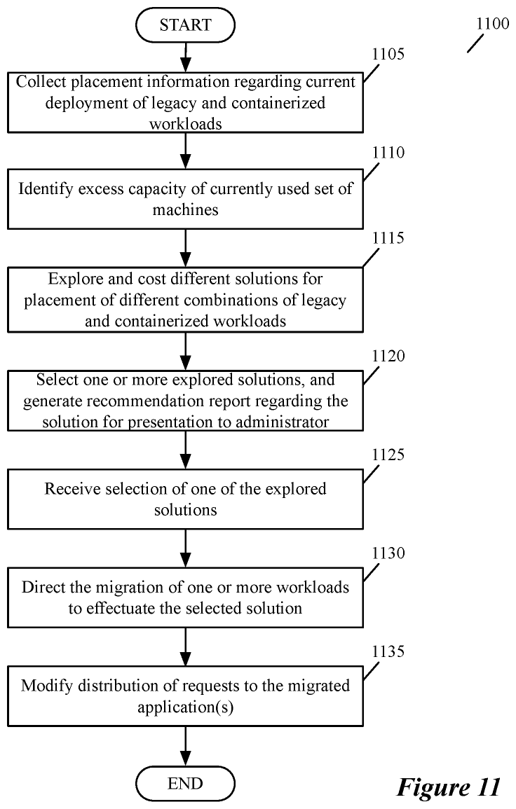

FIG. 11 illustrates a process 1100 that the recommendation engine 1020 of the global controller 310 performs in some embodiments to provide recommendations regarding optimized deployments of workloads and to implement a recommendation that is selected by an administrator. As shown, the process 1100 initially collects (at 1105) placement information regarding current deployment of legacy and containerized workloads. In some embodiments, these machines can operate in one or more VPCs defined in one or more public or private clouds. To perform the operation at 1105, the process 1100 retrieves this data from a data store of the global controller.

Next, at 1110, the process 1100 computes excess capacity of the machines identified at 1105. The process 1100 performs this computation by retrieving and analyzing the data samples stored in the time series database 1035, as described above. For each identified machine in the set, the process 1100 identifies excess capacity of the set of resources allocated to the machine. In some embodiments, a capacity-harvesting agent 345 executes on each examined machine and iteratively collects resource consumption data, as described above. In these embodiments, the process 1100 uses the collected resource consumption data (e.g., the data stored in a time series data store 360) to compute available excess capacity of each examined machine.

At 1115, the process 1100 explores different solutions for packing different combinations of legacy and containerized workloads onto existing and new machines in one or more VPCs. In some embodiments, the search engine 1025 uses a constrained optimization search process to explore the different packing solutions and to select an optimal solution from the explored solutions. The constrained optimization search process of some embodiments uses the costing engine 1030 to compute a cost function that accounts for one or more types of costs. Examples of such costs in some embodiments include resource consumption efficiency cost (meant to reduce the wasting of excess capacity), financial cost (accounting for cost of deploying machines in public clouds), affinity cost (meant to bias towards closer placement of applications that communicate with each other), etc.

The process 1100 then generates (at 1120) a report that includes one or more recommendations for one or more possible optimizations to the current deployment of the legacy and containerized workloads. It then provides (at 1120) this report to the network administrator through one or more mechanisms, such as (1) an email to the administrator, (2) a browser interface through which the network administrator can query the global controller's webservers to retrieve the report, (3) an API call to a monitoring program used by the network administrator, etc.

The administrator reviews this report and accept (at 1125) one or more of the presented recommendations. The recommendation engine 1020 then directs the workload manager 1010 to instruct (at 1130) the VPC controller cluster(s) to migrate one or more legacy workloads and/or containerized workloads in order to implement the selected recommendation. For this migration, the VPC controllers also configures (at 1135) forwarding elements and/or load balancers in one or more affected VPCs to forward API (application programming interface) requests that are sent to the migrated workload applications to the new machine on which the workloads now execute. The process 1100 then ends.

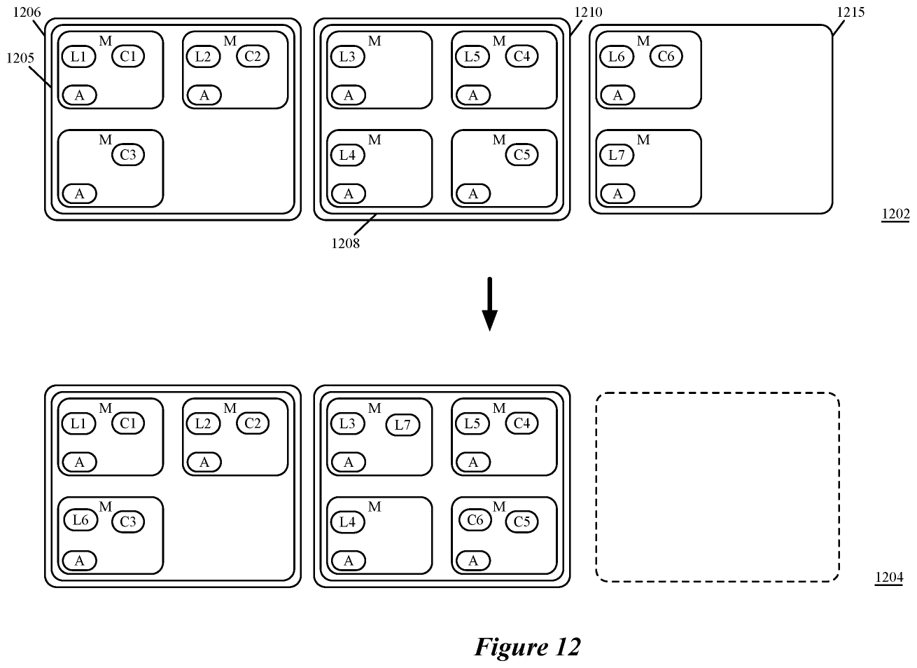

FIG. 12 illustrates an example of re-deployment of workloads pursuant to a recommendation generated by the recommendation engine 1020. This example presents two stages 1202 and 1204 of workload deployments for an entity (e.g., a corporation). Both stages show the workloads deployed on public cloud machines, which in turn execute on host computers (not shown). The workloads include legacy workloads (LWLs) and containerized workloads (CWLs). Each machine is also shown to execute a capacity harvesting agent A.

The first stage 1202 shows that initially a number of workloads for one entity are deployed in three different VPCs that are defined in the public clouds of two different public cloud providers, with a first VPC 1205 being deployed in a first availability zone 1206 of a first public cloud provider, a second VPC 1208 being deployed in a second availability zone 1210 of the first public cloud provider, and a third VPC 1215 being deployed in a datacenter of a second public cloud provider.

The second stage 1204 shows the deployment of the workloads after an administrator accepts a recommendation to move all the workloads to the public cloud of the first public cloud provider. As shown, all the workloads in the third VPC 1215 have migrated to the two availability zones 1206 and 1210 of the first public cloud provider. The third VPC appears with dashed lines to indicate that it has be terminated. In some embodiments, the migration of the workloads from the third VPC reduces the deployment cost of the entity as it packs more workloads on the fewer number of public cloud machines, and consumes less external network bandwidth as it would eliminate bandwidth that is consumed by communication between machines in different public clouds of different public cloud providers.

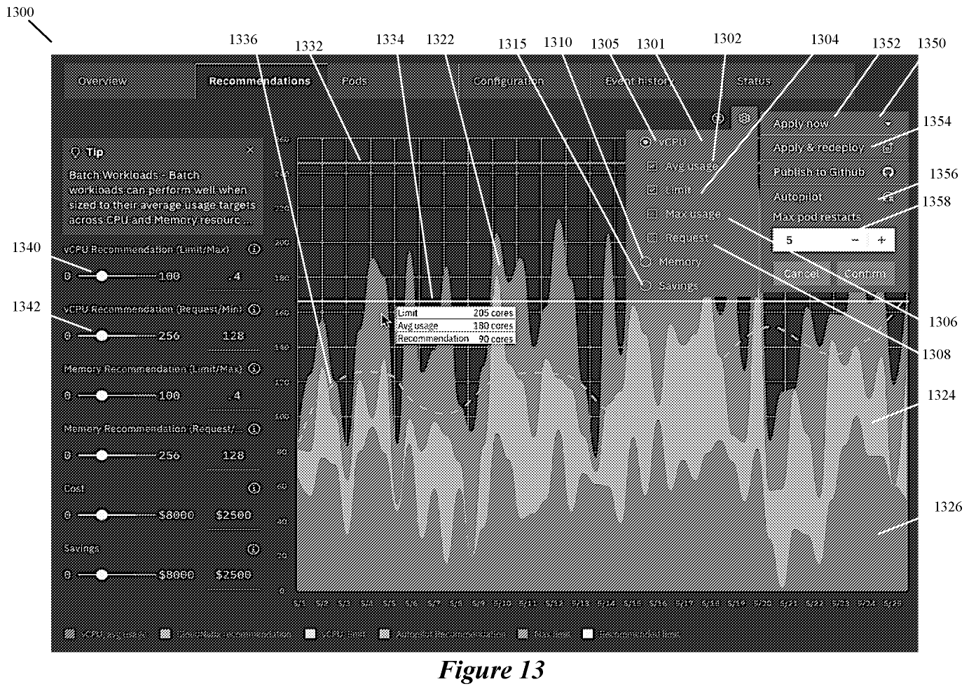

In some embodiments, the global controller provides the right-sizing recommendation via a user interface (UI) 1300 illustrated in FIG. 13. This UI shows the cost associated with the resizing of one workload (e.g., containerized workload) so that a network administrator can assess the impact of optimization. Specifically, the UI provides controls to see the cost and risk impact of the right-sizing a workload as well as allow the administrator to customize the recommendation before applying. The administrator can then select (e.g., click a button) to apply the recommendation.

In some embodiments, the recommendation engine in the VPC cluster controller communicates with the global controller to apply the recommendations automatically by performing the set of steps a human operator would take in resizing a VM, a Pod, or a container. These steps include non-disruptively adjusting the CPU capacity, memory capacity, disk capacity, GPU capacity available to a container or Pod without requiring a restart.

These steps in some embodiments also include non-disruptively adjusting the CPU capacity, memory capacity, disk capacity, GPU capacity available to a VM with hot resize when supported by underlying Virtualization platforms. In platforms that do not support hot resize, some embodiments ensure the VM's identity and state remain unchanged, by ensuring the VM's OS and data volumes are snapshotted and re-attached to the resized VMs. Some embodiments also persist the VM's externally facing IP or in case of VM Pool, maintain a consistent load balanced IP post resize. In this manner, some embodiments in a closed loop fashion performed all necessary steps to resize VM similar to how a human operator would resize it even when the underlying virtualization platforms do not support hot resize.

In the UI 1300, the administrator can view recommendations versus usage metrics for every several different types of resource consumed by the workload (e.g., the container being monitored). In this example, a window 1301 displays a vCPU resource 1305, and a memory resource 1310, along with a savings option 1315. For the selected vCPU resource 1305, the window 1310 illustrates (1) an average vCPU usage 1302 corresponding to an average observed (actual) usage of the vCPU by the monitored workload, (2) a max vCPU usage 1306 corresponding to a maximum observed usage of the vCPU by the monitored workload, (3) a limit usage 1304 corresponding to a configured maximum vCPU usage for the monitored workload, and (4) a request usage 1308 corresponding to a configured minimum vCPU usage for the monitored workload.

In some embodiments, the UI 1300 also provides visualization of other vCPU usages, such as P99% vCPU usage and P95% vCPU usage, as well as recommended min and maximum vCPU usages. In sum, there are at least three types of usage parameters that the UI 1300 can display in some embodiments. These are configured max and min usage parameters, observed max and min usage parameters and recommended max and min usage parameters. In some of these embodiments, the configured and recommended parameters are shown as straight or curved line graphs, while the observed parameters are shown as waves with solid interiors.

In the example of FIG. 13, the wave 1322 is max observed usage (P100), the wave 1324 is P99 usage (usage that is observed for the 99 percentile), and the wave 1326 is the average usage (also called the P50 usage). An X percentile usage means that X % of the usage samples should be below this given usage number, and only 100-X % of the usage sample are allowed to be higher than PX usage. FIG. 13 also illustrates a configured max usage (limit) 1332, a recommended max usage (limit) 1334, and a recommended max vCPU (limit) 1336 for autopilot mode, which will be described below.

The UI 1300 allows an administrator to adjust the recommended vCPU max and min usages through the slider controls. In this example, the network administrator can adjust the recommended max CPU through the slider 1340, and adjust the recommended min CPU usage through the slider 1342, before accepting/applying the recommendation. As shown, the UI includes sliders for memory max and min usages, as well as cost and saving sliders, which will be described further below.

The UI 1300 allows an administrator to visualize and adjust memory metrics memory option 1310 in the window 1301. Selection of this option enables Memory Resource Metric Visualization, which allows the administrator to visualize recommendations and adjust these recommendation in much the same way as the CPU recommendations can be visualized and adjusted.

The third option 1315 in the window 1301 is the “Savings” option. Enabling this radio button lets the user visualize (1) cost (e.g., money spent) for the configured max CPU or memory resource, (2) cost used (e.g., money spent) for used CPU or Memory resource, and (3) cost recommended (e.g., the recommended amount of money that should be spent) for the recommended amount of resources to consume. The delta between the recommended cost recommended and spent cost is “Savings”. The Cost UI control lets the administrator adjust its target cost and see the controls for CPU/Mem on the left hand side dynamically move to account for the administrator's desire for a target cost.

When the administrator is satisfied with a recommendations and any adjustment made to the recommendation by the user, the administrator can direct the global controller to apply the recommendation through the Apply control 1350. Selection of this control presents the apply now control 1352, the re-deploy control 1354, and the auto-pilot control 1356. The selection of the apply now control 1352 updates the resource configuration of the machine (e.g., Pod or VM at issue) just-in-time.

When the “apply now” option is selected for a Pod, some embodiments leverage the capacity harvesting agent to reconfigure the Pod's CPU/memory settings. For VMs, some embodiments use another set of techniques to adjust the size just-in-time. For instance, some embodiments take a snapshot of VM's disk, then create a new VM with new CPU/memory settings, attach the disk snapshot and point old VM's public facing IP to the new VM. Some embodiments also allow for scheduled “re-size” of the VM so that the VM can be re-sized during maintenance window of the VM.

The selection of the apply via re-deploy control 1354 re-deploys the machine with new resource configuration. The selection of the auto-pilot control 1356 causes the presentation of the window 1358, which directs the administrator to specify a policy around how many times the machine can be restarted in order to “continuously” apply right-sizing rules. The apply controls 1350 in other embodiments include additional controls such as a dismiss control to show prior dismissed recommendations.

In some embodiments, the recommendations are applicable for a workload, which is the aggregate of the Pods in a set of one or more Pods. The sizes of the Pods in the set of Pods are adjusted using techniques available in K8s and OSS. Some of these techniques are described in https://github.com/kubernetes/enhancements/issues/1287. Some embodiments also adjust the Pod size via a re-deploy option 1354, or an auto-pilot with max Pod restart options 1356 and 1358 that iteratively re-deploys until the desired metrics are achieved.

Also, in some embodiments, the right-sizing recommendations computes the CPU/memory savings and modeled cost in order to allow the administrator to assess the financial impact of the right-sizing. Some embodiments: (1) compute the [Cost per VM/2]/[# of CPU MilliCores] and model the cost per MilliCore consumed by a container running on a VM, and (2) take [Cost per VM/2]/[# of Mem. MiB] and model the cost per MiB consumed by a container running on a VM.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

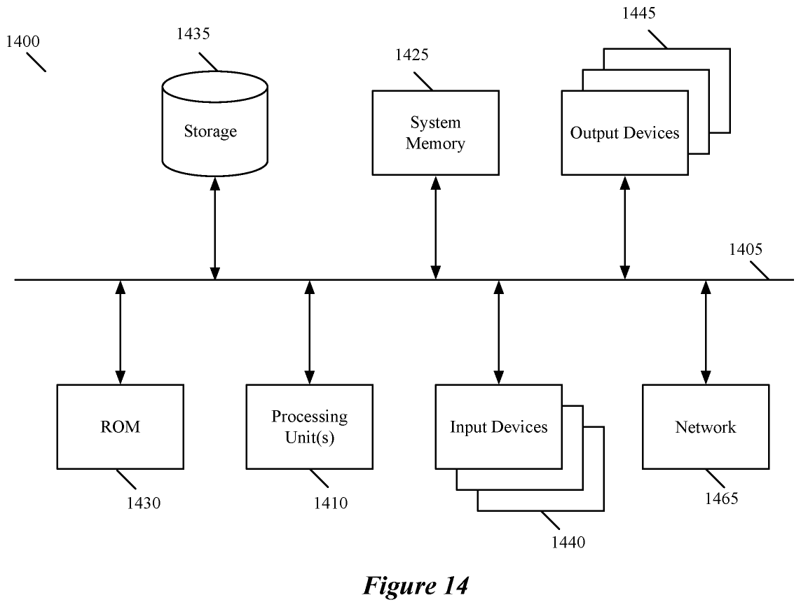

FIG. 14 conceptually illustrates an electronic system 1400 with which some embodiments of the invention are implemented. The electronic system 1400 may be a computer (e.g., a desktop computer, personal computer, tablet computer, server computer, mainframe, a blade computer etc.), or any other sort of electronic device. As shown, the electronic system includes various types of computer readable media and interfaces for various other types of computer readable media. Specifically, the electronic system 1400 includes a bus 1405, processing unit(s) 1410, a system memory 1425, a read-only memory 1430, a permanent storage device 1435, input devices 1440, and output devices 1445.

The bus 1405 collectively represents all system, peripheral, and chipset buses that communicatively connect the numerous internal devices of the electronic system 1400. For instance, the bus 1405 communicatively connects the processing unit(s) 1410 with the read-only memory (ROM) 1430, the system memory 1425, and the permanent storage device 1435. From these various memory units, the processing unit(s) 1410 retrieve instructions to execute and data to process in order to execute the processes of the invention. The processing unit(s) may be a single processor or a multi-core processor in different embodiments.

The ROM 1430 stores static data and instructions that are needed by the processing unit(s) 1410 and other modules of the electronic system. The permanent storage device 1435, on the other hand, is a read-and-write memory device. This device is a non-volatile memory unit that stores instructions and data even when the electronic system 1400 is off. Some embodiments of the invention use a mass-storage device (such as a magnetic or optical disk and its corresponding disk drive) as the permanent storage device 1435.

Other embodiments use a removable storage device (such as a floppy disk, flash drive, etc.) as the permanent storage device. Like the permanent storage device 1435, the system memory 1425 is a read-and-write memory device. However, unlike storage device 1435, the system memory is a volatile read-and-write memory, such a random access memory. The system memory stores some of the instructions and data that the processor needs at runtime. In some embodiments, the invention's processes are stored in the system memory 1425, the permanent storage device 1435, and/or the read-only memory 1430. From these various memory units, the processing unit(s) 1410 retrieve instructions to execute and data to process in order to execute the processes of some embodiments.

The bus 1405 also connects to the input and output devices 1440 and 1445. The input devices enable the user to communicate information and select commands to the electronic system. The input devices 1440 include alphanumeric keyboards and pointing devices (also called “cursor control devices”). The output devices 1445 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 14, bus 1405 also couples electronic system 1400 to a network 1465 through a network adapter (not shown). In this manner, the computer can be a part of a network of computers (such as a local area network (“LAN”), a wide area network (“WAN”), or an Intranet, or a network of networks, such as the Internet. Any or all components of electronic system 1400 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. For instance, a number of the figures conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process.

Also, while the excess capacity harvesting agents are deployed on machines executing on host computers in several of the above-described embodiments, these agents in other embodiments are deployed outside of these machines on the host computers (e.g., on hypervisors executing on the host computers) on which these machines operate. Therefore, one of ordinary skill in the art would understand that the invention is not to be limited by the foregoing illustrative details, but rather is to be defined by the appended claims.

1. A method of optimizing deployment of containerized applications across a plurality of virtual private clouds (VPCs) defined in a set of one or more datacenters, the method comprising:
at a set of one or more global controllers:
collecting operational data from each of a plurality of cluster controllers each of which is associated with one VPC and is responsible for deploying containerized applications in its associated VPC;
analyzing the operational data to identify modifications to the deployment of one or more containerized applications in one or more VPCs;
producing a recommendation report for display to present the identified modifications as recommendations to an administrator of the plurality of VPCs.

2. The method of claim 1, wherein the containerized applications execute on machines operating on host computers in the set of datacenters.

3. The method of claim 2, wherein the identified modifications comprise moving a group of one or more containerized applications in a first VPC from a larger, first set of machines to a smaller, second set of machines.

4. The method of claim 3, wherein the first and second sets of machines include machines that are in both sets of machines but the second set of machines has fewer machines.

5. The method of claim 4, wherein the second set of machines is a smaller subset of the first set of machines.

6. The method of claim 4, wherein the second set of machines is not just a subset of the first set of machines as the second set of machines includes at least one machine not in the first set of machines.

7. The method of claim 3, wherein moving to the smaller, second set of machines reduces a cost of the deployment of the containerized applications by using less deployed machines to execute the containerized applications.

8. The method of claim 1, wherein analyzing operational data comprises:
identifying possible migrations of each of a group of containerized applications to new candidate machines for executing containerized application;
for each possible migration, using a costing engine to compute a cost associated with the migration;
using the computed costs to identify the possible migrations that should be recommended;
including in the recommendation report each possible migration that is identified as a migration that should be recommended.

9. The method of claim 8, wherein
the computed costs are used to calculate different output values of a cost function, with each output value associated with a different deployment of the group of containerized applications, and
using the computed costs comprises using the calculated output values of the cost function to identify the possible migrations that should be recommended.

10. The method of claim 8, wherein the computed costs comprise financial costs for deploying a set of containerized applications in at least two different public clouds.

11. The method of claim 10, wherein the two different public clouds are operated by two different public cloud providers.

12. The method of claim 1, wherein
analyzing operational data comprises identifying possible adjustments to resources allocated to each of a group of containerized applications;
producing a recommendation report comprises generating a recommended adjustment to at least a first allocation of a first resource to at least a first container/Pod on which a first container application executes.

13. The method of claim 1, wherein collecting operational data comprises collecting time-series operational data stored in databases used by the cluster controllers to store different sets of operational data collected at different times from host computers on which the containerized applications operate in each VPC.

14. The method of claim 1 further comprising:
receiving user input accepting a recommended migration of a first containerized application from a first machine in a first VPC to a second machine in the first VPC;
directing a first cluster controller set of the first VPC to direct he migration of the first containerized application.

15. The method of claim 14, wherein the first and second machines execute on first and second host computers respectively.

16. The method of claim 15, wherein the first and second machines execute on a same host computer.

17. The method of claim 1, wherein analyzing operational data comprises:
identifying possible migrations of each of a group of containerized applications to new candidate machines for executing containerized application;
including in the recommendation report one or more of the possible migrations along with a financial cost saving associated with each possible migration.

18. The method of claim 1, wherein analyzing operational data comprises:
identifying adjustment to allocations of resources of a set of host computers to each of a group of containerized applications executing on the set of host computers;
including in the recommendation report one or more of the identified resource allocation adjustments along with a cost associated with each identified resource allocation adjustment.

19. A non-transitory machine readable medium storing a program that when executed by at least one processing unit of a computer optimizes deployment of containerized applications across a plurality of virtual private clouds (VPCs) defined in a set of one or more datacenters, the program comprising sets of instructions for:
collecting operational data from each of a plurality of cluster controllers each of which is associated with one VPC and is responsible for deploying containerized applications in its associated VPC;
analyzing the operational data to identify modifications to the deployment of one or more containerized applications in one or more VPCs;
producing a recommendation report for display to present the identified modifications as recommendations to an administrator of the plurality of VPCs.
